(19) United States
(12) Patent Application Publication
(10) Pub. No.: US 2012/0214902 A1
(43) Pub. Date: Aug. 23, 2012

(54) Paintable Elastomer

(76) Inventors: Tommy Detemmerman, Wezembeek-Oppem (BE); Frederic Gubbels, Houtain-le-Val (BE); Stephanie Lobry, Rombies et Marchipoint (FR)

(21) Appl. No.: 13/503,938

(22) PCT Filed: Oct. 25, 2010
(86) PCT No.: PCT/EP2010/066088

§ 371 Date: Apr. 25, 2012

(30) Foreign Application Priority Data
Oct. 26, 2009 (EP) EP 09306011.9

(51) Int. Cl. C08L 83/04; B05D 5/00; C08J 5/00; C08K 5/09

(52) U.S. Cl. 523/122; 524/322; 524/588; 427/256; 264/331.11

(57) ABSTRACT

This invention relates to the provision of a room temperature vulcanisable (RTV) elastomeric composition which contains one or more silicone based polymers and which is paintable with a variety of paints. The application also relates to a method for producing a painted surface on an elastomer obtained from said composition. The curable composition capable of cure to an elastomeric body comprises a diluted polymer comprising a high molecular weight organopolysiloxane polymer having an organopolysiloxane chain having a number average molecular weight (Mₙ) of at least 100,000 and terminal groups selected from either silanol and/or other hydrolysable groups; or unsaturated groups; and one or more an organic plasticiser(s) and/or one or more organic extender(s) or a mixture thereof (component (a). Other ingredients are a suitable amount of one or more cross-linkers for cross-linking the polymer, a suitable amount of catalyst, one or more fillers; and either of the following: one or more organic polymers having terminal and/or pendent silyl groups containing —OH functional groups or hydrolysable functional groups, or one or more organic polymers having terminal and/or pendent silyl groups containing one or more unsaturated groups. The composition comprises up to 8% by weight of the high molecular weight organopolysiloxane polymer in component (a).

This invention relates to the provision of a room temperature vulcanisable (RTV) elastomeric composition which contains one or more silicone based polymers and which is paintable with a variety of paints. The application also relates to a method for producing a painted surface on an elastomer obtained from said composition.

Organopolysiloxane compositions which cure to produce elastomers at room temperature are widely used as sealants and caulking materials because they have a unique property profile for applications, such as in building construction. These properties include excellent weatherability, resistance to heat, maintenance of flexibility at low temperatures, ease of application and rapid cure in place. However, the structures on which such sealants and caulking materials are used are often coated with, typically organic based, decorative and protective coatings, such as paints, varnishes, lacquers and shellacs. Generally silicone elastomers have a disadvantage in that they do not provide surfaces coatable with such organic based decorative and protective coatings.

The paintability of silicone based elastomers with solvent and water-based paints is an acknowledged difficult challenge for the industry. Current thinking is that the painting process requires the wetting of a silicone material exhibiting both a low surface energy due to the presence of alkyl e.g. methyl groups present on the siloxane backbone and a flexible polymer chain, which allows fast reorganization of the surface to minimize the surface energy. As a result of this physical limitation silicone sealants and elastomers are generally considered in various industries to be effectively unpaintable. This is because in many silicone based sealant formulations immediately on painting the paint shrinks away from the silicone elastomeric surface leading to a poor appearance commonly referred to “fish eyes” in the industry.

A wide variety of solutions to the problem of the lack of paintability of cured silicone elastomers have been proposed. However, many of these provide specific room temperature curable (RTV) silicone compositions, containing high levels of organic solvents, which cure to elastomers with paintable surfaces to which at least one type of decorative or protective paint may be applied. These solvent containing compositions may be environmentally unacceptable because they have too high a volatile organic content (VOC) due to the high levels of organic solvents present in the uncured composition. Furthermore, high shrinkage caused by the evaporation of the aforementioned organic solvent(s) has a negative effect on the sealing capability of these sealants.

Several publications propose paintable sealant compositions. These include U.S. Pat. No. 3,817,894, U.S. Pat. No. 4,515,834, U.S. Pat. No. 4,247,445, U.S. Pat. No. 4,358,558 and U.S. Pat. No. 4,985,476. U.S. Pat. No. 4,968,760 proposes one- or two-component compositions, based on branched organosiloxane chains, which, when cured, can be painted or coated. Disadvantages of these systems include the higher cost of producing branched-chain organosiloxanes and the high tensile stresses at 100% elongation in the range of 0.45 to 0.75 N/mm² (in accordance with DIN 53504), which, for many applications, render them unsuitable as joint sealant.

EP 0096424 describes the use of specific substituted alcohols as additives in a silicone composition which contains a cross-linker having amido and/or aminoxy reactable groups. It is proposed that the introduction of these alcoholic additives renders the elastomeric product resulting from the cure of this composition paintable. U.S. Pat. No. 5,326,845 describes a paintable composition comprising a hydroxyl-functional siloxane having a molecular weight of less than 5,000 and a polyisocyanate as a crosslinker. Whilst this formulation may depict reasonable paintability, the reliance on such low molecular weight silicone polymers results in other limitations, not least the fact that low modulus sealants will result. US2005/0054765 proposes a polyorganosiloxane composition which is said to be paintable upon cure. The composition utilises oximo functional or benzamido functional cross-linkers and 1 to 18% by weight of specific alkylaromatic compound.

WO2006/106362 and WO2006/106095 introduced a new method of producing organopolysiloxane compositions by polymerizing the organopolysiloxane polymer from monomers/oligomers in the presence of plasticisers and/or extenders which are retained in the polymer composition after polymerisation is completed. This concept lead to a method for producing high molecular weight polymers without the usual accompanying problem of having unmanageably high polymer viscosity. WO 2006/106095 was specifically directed to the use of such polymers in the preparation of compositions which resulted in paintable elastomeric surfaces once cured.

One concept which has been utilised to render paintable cured elastomeric surfaces has been to replace the organopolysiloxane polymers in such compositions as described in paragraphs [0005] and [0006] above with silicon containing organic polymers. These are typically in the form of silyl terminated polyethers or polyurethanes or the like. However, whilst the presence of silicon containing functional groups in the polymer are retained many of the advantages of organopolysiloxane polymer compositions such as adhesion and mechanical properties are lost

U.S. Pat. No. 4,902,575, U.S. Pat. No. 4,906,707, U.S. Pat. No. 4,965,311, and U.S. Pat. No. 5,063,270 propose cross-linkable compositions based on modified silicone (MS) polymers that have polymer frameworks built from polyethers such as polyethylene oxide and polypropylene oxide and are said to produce, upon curing, paintable surfaces suitable for painting using alkyd paints.

WO02/062893 describes a sealant coatable by alkyd paints comprising a silane terminated polyether, condensation catalyst, cross-linking agent and a liquid paraffinic hydrocarbon processing aid. U.S. Pat. No. 5,326,845 describes a one part sealant comprising a silicone urethane co-polymer.

WO2006/002425 describes a composition comprising hydroxyl-functional siloxanes and silyl terminated polyethers and/or polyurethanes. This is said to exhibit a good painted surface with no fish-eyes, but it should be noted that in all the examples the paint has been immediately applied after cure of the sealant. It is known to the people skilled in the art that freshly cured silicone sealants may be paintable, but this paintability decreases significantly with time. Current beliefs are that this phenomenon is linked to the rearrangement of the non polar methyl groups at the surface of the substrate to reduce overall surface energy.

In accordance with the present invention there is provided a moisture curable composition capable of cure to an elastomeric body comprising:
(a) a diluted polymer comprising
   (i) a high molecular weight organopolysiloxane polymer having an organopolysiloxane chain having a number average molecular weight (Mₙ) of at least 100,000 and terminal groups selected from either silanol and/or other hydrolysable groups; or unsaturated groups; and
   (ii) one or more an organic plasticiser(s) and/or one or more organic extender(s) or a mixture thereof;
(b) a suitable amount of one or more suitable cross-linkers for cross-linking (a)
(c) a suitable amount of catalyst
(d) one or more fillers; and either (e) or (f), selected to chemically interact with (a) and (b), wherein
(e) is one or more organic polymers having terminal and/or pendent silyl groups containing —OH functional groups or hydrolysable functional groups, and
(f) is one or more organic polymers having terminal and/or pendent silyl groups containing one or more unsaturated groups, selected in accordance with the terminal groups of (a);
   characterised in that the composition comprises up to 8% by weight of the high molecular weight organopolysiloxane polymer in component (a).

The concept of “comprising” where used herein is used in its widest sense to mean and to encompass the notions of “include” and “consist of”. Unless otherwise indicated all viscosity values given are at a temperature of 25° C. and all compositions and ranges provided as % are intended to be part of a composition which cumulatively adds up to 100%. For the purpose of this application “Substituted” means one or more hydrogen atoms in a hydrocarbon group has been replaced with another substituent. Examples of such substituents include, but are not limited to, halogen atoms such as chlorine, fluorine, bromine, and iodine; halogen atom containing groups such as chloromethyl, perfluorobutyl, trifluoroethyl, and nonafluorohexyl; oxygen atoms; oxygen atom containing groups such as (meth)acrylic and carboxyl; nitrogen atoms; nitrogen atom containing groups such as amino-functional groups, amido-functional groups, and cyano-functional groups; sulphur atoms; and sulphur atom containing groups such as mercapto groups.

The diluted polymer comprises an organopolysiloxane polymer component (a) (i) having a number average molecular weight (Mₙ) of at least 100,000 as determined following ASTM D5296-05 and calculated as polystyrene molecular weight equivalents. For organopolysiloxane polymers an Mₙ value of 100,000 would typically have a viscosity of greater than 1,000,000 mPa·s at 25° C.

Preferably the organopolysiloxane polymer component (a) (i) has the general formula:

X²-A-X¹ (1)

where X² and X¹ are independently selected from silyl groups substantially all comprising either
(I) at least one hydroxyl or hydrolysable group; or
(II) at least one unsaturated group.

Examples of groups X² or X¹ when they contain at least one hydroxyl or hydrolysable group include —Si(OH)₃, —(R^{a})Si(OH)₂, —(R^{a})₂SiOH, —R^{a}Si(OR^{b})₂, —Si(OR^{b})₃, —R^{a}₂SiOR^{b} or —R^{a}₂Si—R^{c}—SiR^{d}ₚ(OR^{b})₃₋ₚ where each R^{a} independently represents a monovalent hydrocarbyl group, for example, an alkyl group, in particular having from 1 to 8 carbon atoms, (and is preferably methyl); each R^{b} and R^{d} group is independently an alkyl or alkoxy group in which the alkyl groups suitably have up to 6 carbon atoms; R^{c} is a divalent hydrocarbon group which may be interrupted by one or more siloxane spacers having up to six silicon atoms; and p has the value 0, 1 or 2. Preferably X² and/or X¹ contain hydroxyl groups or groups which are otherwise hydrolysable in the presence of moisture. In one embodiment a proportion (up to 20%) of X² groups may be trialkylsilyl groups.

Examples of groups X² or X¹ when they contain at least one at least one unsaturated group include alkenyl terminated e.g. ethenyl terminated, propenyl terminated, allyl terminated (CH₂═CHCH₂—)) or they may be terminated with acrylic or alkylacrylic such as CH₂═C(CH₃)—CH₂— groups. Representative, non-limiting examples of the alkenyl groups are shown by the following structures; H₂C═CH—, H₂C═CHCH₂—, H₂C═C(CH₃)CH₂—, H₂C═CHCH₂CH₂—, H₂C═CHCH₂CH₂CH₂—, and H₂C═CHCH₂CH₂CH₂CH₂—. Representative, non-limiting examples of alkynyl groups are shown by the following structures; HCEC-, HCECCH₂—, HCECC(CH₃)—, HCECC(CH₃)₂— and HCECC(CH₃)₂CH₂—. Alternatively, the unsaturated organic group can be an organofunctional hydrocarbon such as an acrylate, methacrylate. Alkenyl groups, e.g. vinyl groups are particularly preferred.

Examples of suitable siloxane containing polymeric chain A in formula (1) are those which comprise a polydiorganosiloxane chain. Thus group A preferably includes siloxane units of formula (2):

—(R5sSiO(4-s)/2)- (2)

in which each R⁵ is independently an organic group such as a hydrocarbon group having from 1 to 18 carbon atoms, a substituted hydrocarbon group having from 1 to 18 carbon atoms or a hydrocarbonoxy group having up to 18 carbon atoms and s has, on average, a value of from 1 to 3, preferably 1.8 to 2.2. Preferably R⁵ is a hydrocarbyl group having from 1 to 10 carbon atoms optionally substituted with one or more halogen group such as chlorine or fluorine and s is 0, 1 or 2. Particular examples of groups R⁵ include methyl, ethyl, propyl, butyl, vinyl, cyclohexyl, phenyl, tolyl group, a propyl group substituted with chlorine or fluorine such as 3,3,3-trifluoropropyl, chlorophenyl, beta-(perfluorobutyl)ethyl or chlorocyclohexyl group. Suitably, at least some and preferably substantially all of the groups R⁵ are methyl.

Polymeric chain A in the compound of formula (1) may include any suitable siloxane or siloxane/organic molecular chain. The resulting polymer may have a viscosity (in the absence of plasticisers and or extenders in accordance with the present invention) of up to at least 20 000 000 mPa·s, at 25° C. (i.e. a degree of polymerisation (dp) of up to or even more than 200 000 units of formula (2)). In one preferred embodiment polymeric chain A is a linear organopolysiloxane molecular chain (i.e. s=2) for all chain units. Preferred materials have polydiorganosiloxane chains according to the general formula (3):

—(R52SiO)t- (3)

in which each R⁵ is as defined above and is preferably a methyl group and t has a value of up to or even more than 200 000. Suitable polymers have viscosities of up to at least 20 000 000 mPa·s at 25° C. in the absence of the extender(s) but when prepared in the presence of the extender(s) viscosities are generally in the order of 1000 to 100 000 mPa·s at 25° C. because of the presence of the extender(s) in the polymer matrix. The polydiorganosiloxanes may be homopolymers or copolymers. Mixtures of different polydiorganosiloxanes having terminal condensable groups are also suitable. The high molecular weight organopolysiloxane polymer in component (a) must be present in the composition and can be present in an amount of from 0.1% by weight to 8% by weight of the composition.

Any suitable plasticiser(s) and/or extender(s) or combination thereof may be utilised in the diluted polymer as component (a) (ii). For the avoidance of doubt, for the sake of this invention “suitable” means they must be substantially and preferably completely miscible with the organopolysiloxane in diluted polymer (a), however they need not be miscible with organic polymer(s) of component (e). These include each of the following alone or in combination with others from the list:
trialkylsilyl terminated polydialkylsiloxane where each alkyl group may be the same or different and comprises from 1 to 6 carbon atoms but is preferably a methyl group, preferably with a viscosity of from 100 to 100 000 mPa·s at 25° C. and most preferably from 1000 to 60 000 mPa·s at 25° C.;
polyisobutylenes (PIB),
phosphate esters such as trioctyl phosphate,
polyalkylbenzenes,
linear and/or branched alkylbenzenes such as heavy alkylates, dodecyl benzene and other alkylarenes,
esters of aliphatic monocarboxylic acids,
unreactive short chain siloxanes,
linear or branched mono unsaturated hydrocarbons such as linear or branched alkenes or mixtures thereof containing from 12 to 25 carbon atoms; and/or mineral oil fractions comprising linear (e.g. n-paraffinic) mineral oils, branched (iso-paraffinic) mineral oils, cyclic (referred in some prior art as naphthenic) mineral oils and mixtures thereof. Preferably the hydrocarbons utilised comprise from 5 to 25 carbon atoms per molecule.

Preferred extenders include the mineral oil fractions, alkylcycloaliphatic compounds, and alkybenzenes including polyalkylbenzenes.

Other preferred mineral oil extenders include alkylcycloaliphatic compounds and alkybenzenes including polyalkylbenzenes.

Any suitable mixture of mineral oil fractions may be utilised as the extender in the present invention but high molecular weight extenders (e.g. a number average molecular weight >220) are particularly preferred. Examples include:

alkylcyclohexanes (having a number average molecular weight >220);
paraffinic hydrocarbons and mixtures thereof containing from 1 to 99%, preferably from 15 to 80% n-paraffinic and/or isoparaffinic hydrocarbons (linear branched paraffinic) and 1 to 99%, preferably 85 to 20% cyclic hydrocarbons (naphthenic) and a maximum of 3%, preferably a maximum of 1% aromatic carbon atoms. The cyclic paraffinic hydrocarbons (naphthenics) may contain cyclic and/or polycyclic hydrocarbons. Any suitable mixture of mineral oil fractions may be used, e.g. mixtures containing
(i) 60 to 80% paraffinic and 20 to 40% naphthenic and a maximum of 1% aromatic carbon atoms;
(ii) 30-50%, preferably 35 to 45% naphthenic and 70 to 50% paraffinic and or isoparaffinic oils;
(iii) hydrocarbon fluids containing more than 60 wt. % naphthenics, at least 20 wt. % polycyclic naphthenics and an ASTM D-86 boiling point of greater than 235° C.;
(iv) hydrocarbon fluid having greater than 40 parts by weight naphthenic hydrocarbons and less than 60 parts by weight paraffinic and/or ispoaraffinic hydrocarbons based on 100 parts by weight of hydrocarbons.

Preferably the mineral oil based extender or mixture thereof comprises at least one of the following parameters:
(i) a molecular weight of greater than 150, most preferably greater than 200;
(ii) an initial boiling point equal to or greater than 230° C. (according to ASTM D 86).
(iii) a viscosity density constant value of less than or equal to 0.9; (according to ASTM 2501)
(iv) an average of at least 12 carbon atoms per molecule, most preferably 12 to 30 carbon atoms per molecule;
(v) an aniline point equal to or greater than 70° C., most preferably the aniline point is from 80 to 110° C. (according to ASTM D 611);
(vi) a naphthenic content of from 20 to 70% by weight of the extender and a mineral oil based extender has a paraffinic content of from 30 to 80% by weight of the extender according to ASTM D 3238);
(vii) a pour point of from −50 to 60° C. (according to ASTM D 97);
(viii) a kinematic viscosity of from 1 to 20 cSt at 40° C. (according to ASTM D 445)
(ix) a specific gravity of from 0.7 to 1.1 (according to ASTM D1298);
(x) a refractive index of from 1.1 to 1.8.at 20° C. (according to ASTM D1218)
(xi) a density at 15° C. of greater than 700 kg/m³ (according to ASTM D4052) and/or
(xii) a flash point of greater than 100° C., more preferably greater than 110° C. (according to ASTM D 93)
(xiii) a saybolt colour of at least +30 (according to ASTM D156)
(xiv) a water content of less than or equal to 250 ppm (according to ASTM D6304)
(xv) a Sulphur content of less than 2.5 ppm (according to ASTM D 4927)

The alkylbenzene compounds suitable for use include heavy alkylate alkylbenzene or an alkylcycloaliphatic compound. Examples of alkyl substituted aryl compounds useful as extenders and/or plasticisers are compounds which have aryl groups, especially benzene substituted by alkyl and possibly other substituents, and a molecular weight of at least 200. Examples of such extenders are described in U.S. Pat. No. 4,312,801, the content of which is incorporated herein by reference. These compounds can be represented by general formula (I), (II), (III) and (IV)

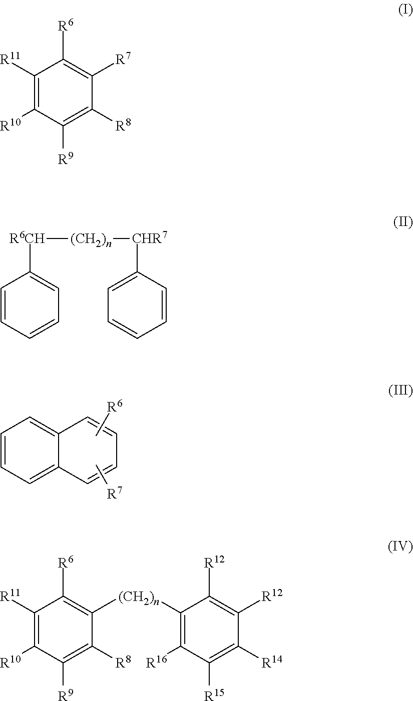

where R⁶ is an alkyl chain of from 1 to 30 carbon atoms, each of R⁷ through to R¹⁶ is independently selected from hydrogen, alkyl, alkenyl, alkynyl, halogen, haloalkyl, nitrile, amine, amide, an ether such as an alkyl ether or an ester such as an alkyl ester group, and n is an integer of from 1 to 25.

In particular, the extender used in accordance with the process of the present invention is of formula (1) where each of R⁷, R⁸, R⁹, R¹⁰ and R¹¹ is hydrogen and R⁶ is a C₁₀-C₁₃ alkyl group. A particularly useful source of such compounds are the so-called “heavy alkylates”, which are recoverable from oil refineries after oil distillation. Generally distillation takes place at temperatures in the range of from 230-330° C., and the heavy alkylates are present in the fraction remaining after the lighter fractions have been distilled off.

Examples of alkylcycloaliphatic compounds are substituted cyclohexanes with a molecular weight in excess of 220. Examples of such compounds are described in EP 0842974, the content of which is incorporated herein by reference. Such compounds may be represented by general formula (V).

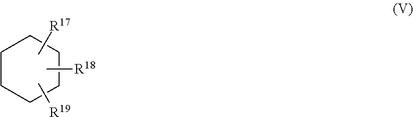

where R¹⁷ is a straight or branched alkyl group of from 1 to 25 carbon atoms, and R¹⁸ and R¹⁹ are independently selected from hydrogen or a C₁₋₂₅ straight or branched chain alkyl group.

The amount of plasticiser and/or extender which may be included in the composition will depend upon factors such as the purpose to which the composition is to be put, the molecular weight of the plasticiser(s) and/or extender(s) concerned etc. Polymer products in accordance with the present invention may contain from 5% w/w up to 70% w/w plasticiser and/or extender (based on the combined weight of polymer and plasticiser(s) and/or extender(s)) depending upon these factors. Typical compositions will contain up to 70% w/w plasticiser and/or extender(s). More suitable polymer products comprise from 30-60% w/w of a linear plasticiser and/or extender(s) whereas 25-35% w/w will be more preferred when the plasticiser and/or extender is a heavy alkylate. Preferably the plasticiser(s) and/or extender(s) are compatible with both (a) and (e) in the composition in accordance with the invention in order to aid compatibilization thereof in the cured composition leading to improved mechanical properties.

Most preferably the extender comprises a mineral oil fraction.

Any suitable cross-linker may be used as (b). A suitable cross-linker (b) when high molecular weight organopolysiloxane polymer (a) (i) contains —OH terminal groups may contain three silicon-bonded hydrolysable groups per molecule; the fourth group is suitably a non-hydrolysable silicon-bonded organic group. These silicon-bonded organic groups are suitably hydrocarbyl groups which are optionally substituted by halogen such as fluorine and chlorine. Examples of such fourth groups include alkyl groups (for example methyl, ethyl, propyl, and butyl); cycloalkyl groups (for example cyclopentyl and cyclohexyl); alkenyl groups (for example vinyl and allyl); aryl groups (for example phenyl, and tolyl); aralkyl groups (for example 2-phenylethyl) and groups obtained by replacing all or part of the hydrogen in the preceding organic groups with halogen. Preferably however, the fourth silicon-bonded organic group is methyl or ethyl.

Specific examples of cross-linkers include alkyltrialkoxysilanes such as methyltrimethoxysilane (MTM) and methyltriethoxysilane, alkenyltrialkoxy silanes such as vinyltrimethoxysilane and vinyltriethoxysilane, isobutyltrimethoxysilane (iBTM). Other suitable silanes include ethyltrimethoxysilane, vinyltriethoxysilane, phenyltrimethoxysilane, alkoxytrioximosilane, alkenyltrioximosilane, 3,3,3-trifluoropropyltrimethoxysilane, methyltriacetoxysilane, vinyltriacetoxysilane, ethyl triacetoxysilane, di-butoxy diacetoxysilane, phenyl-tripropionoxysilane, methyltris(methylethylketoximo)silane, vinyl-tris-methylethylketoximo)silane, methyltris(methylethylketoximino)silane, methyltris(isopropenoxy)silane, vinyltris(isopropenoxy)silane, ethylpolysilicate, n-propylorthosilicate, ethylorthosilicate, dimethyltetraacetoxydisiloxane,

The cross-linker when high molecular weight organopolysiloxane polymer (a) (i) contains —OH terminal groups may also comprise a disilaalkane of the formula:

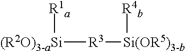

where R¹ and R⁴ are monovalent hydrocarbons, R² and R⁵ are alkyl groups or alkoxylated alkyl groups, R³ is a divalent hydrocarbon group and a and b are 0 or 1. Specific examples include 1,6-bis(trimethoxysilyl)hexane1,1-bis(trimethoxysilyl)ethane, 1,2-bis(trimethoxysilyl)ethane, 1,2-bis(trimethoxysilyl)propane, 1,1-bis(methyldimethoxysilyl)ethane, 1,2-bis(triethoxysilyl)ethane, 1-trimethoxysilyl-2-methyldimethoxysilylethane, 1,3-bis(trimethoxyethoxysilyl)propane, and 1-dimethylmethoxysilyl-2-phenyldiethoxysilylethane.

Further alternative cross-linkers include Alkylalkenylbis(N-alkylacetamido) silanes such as methylvinyldi-(N-methylacetamido)silane, and methylvinyldi-(N-ethylacetamido)silane; dialkylbis(N-arylacetamido) silanes such as dimethyldi-(N-methylacetamido)silane; and dimethyldi-(N-ethylacetamido)silane; Alkylalkenylbis(N-arylacetamido) silanes such as methylvinyldi(N-phenylacetamido)silane and dialkylbis(N-arylacetamido) silanes such as dimethyldi-(N-phenylacetamido)silane. The cross-linker used may also comprise any combination of two or more of the above. A particularly preferred cross-linker is methyltrimethoxysilane.

The cross-linker used may also comprise any combination of two or more of the above. Preferably condensation cross-linkers are present in the composition in a range of about 0.1 to 10% of a crosslinker.

In the case when high molecular weight organopolysiloxane polymer (a)(i) contains unsaturated terminal groups the cure process will proceed via a hydrosilylation reaction pathway and hence the cross-linker will typically contain 3 or more silicon bonded hydrogen groups. To effect curing of the present composition, the organohydrogensiloxane must contain more than two silicon bonded hydrogen atoms per molecule. The organohydrogensiloxane can contain, for example, from about 4-200 silicon atoms per molecule, and preferably from about 4 to 50 silicon atoms per molecule and have a viscosity of up to about 10 Pa·s at 25° C. The silicon-bonded organic groups present in the organohydrogensiloxane can include substituted and unsubstituted alkyl groups of 1-4 carbon atoms that are otherwise free of ethylenic or acetylenic unsaturation. Preferably each organohydrogensiloxane molecule comprises at least 3 silicon-bonded hydrogen atoms in an amount which is sufficient to give a molar ratio of Si—H groups in the organohydrogensiloxane to the total amount of alkenyl groups in polymers (a) and (b) of from 1/1 to 10/1.

When high molecular weight organopolysiloxane polymer (a)(i) has —OH terminal groups or hydrolysable end groups, any suitable condensation catalyst (c) may be utilised to cure the composition these include condensation catalysts including tin, lead, antimony, iron, cadmium, barium, manganese, zinc, chromium, cobalt, nickel, aluminium, gallium or germanium and zirconium. Examples include organic tin metal catalysts such as triethyltin tartrate, tin octoate, tin oleate, tin naphthate, butyltintri-2-ethylhexoate, tinbutyrate, carbomethoxyphenyl tin trisuberate, isobutyltintriceroate, and diorganotin salts especially diorganotin dicarboxylate compounds such as dibutyltin dilaurate, dimethyltin dibutyrate, dibutyltin dimethoxide, dibutyltin diacetate, dimethyltin bisneodecanoate, dibutyltin dibenzoate, stannous octoate, dimethyltin dineodecanoate, dibutyltin dioctoate of which stannous octoates is particularly preferred. Other examples include 2-ethylhexoates of iron, cobalt, manganese, lead and zinc.

Alternative condensation catalysts include titanate or zirconate compounds. Such titanates may comprise a compound according to the general formula Ti[OR]₄ where each R may be the same or different and represents a monovalent, primary, secondary or tertiary aliphatic hydrocarbon group which may be linear or branched containing from 1 to 10 carbon atoms. Optionally the titanate may contain partially unsaturated groups. However, preferred examples of R include but are not restricted to methyl, ethyl, propyl, isopropyl, butyl, tertiary butyl and a branched secondary alkyl group such as 2,4-dimethyl-3-pentyl. Preferably, when each R is the same, R is an unbranched secondary alkyl groups, branched secondary alkyl group or a tertiary alkyl group, in particular, tertiary butyl such as tetrabutyltitanate, tetraisopropyltitante.

For the avoidance of doubt an unbranched secondary alkyl group is intended to mean a linear organic chain which does not have a subordinate chain containing one or more carbon atoms, i.e. an isopropyl group, whilst a branched secondary alkyl group has a subordinate chain of one or more carbon atoms such as 2,4-dimethyl-3-pentyl.

Any suitable chelated titanates or zirconates may be utilised. Preferably the chelate group used is a monoketoester such as acetylacetonate and alkylacetoacetonate giving chelated titanates such as, for example diisopropyl bis(acetylacetonyl)titanate, diisopropyl bis(ethylacetoacetonyl)titanate, diisopropoxytitanium Bis(Ethylacetoacetate) and the like. Examples of suitable catalysts are additionally described in EP1254192 and WO200149774 which are incorporated herein by reference.

Preferably the catalyst, component (c), will be present in an amount of from about 0.1 to 3 weight % of the composition component (a) (i) may be present in a greater amount in cases where chelating agents are used. The catalyst is most preferably based on titanate, but can be based on other moisture curing catalysts.

In the case where the silyl terminal groups in component (a) (i) contain unsaturated groups suitable hydrosilylation catalysts are used. These are typically platinum group metal based catalysts selected from a platinum, rhodium, iridium, palladium or ruthenium catalyst. Platinum group metal containing catalysts useful to catalyse curing of the present compositions can be any of those known to catalyse reactions of silicon bonded hydrogen atoms with silicon bonded alkenyl groups. The preferred platinum group metal for use as a catalyst to effect cure of the present compositions by hydrosilylation is platinum. Some preferred platinum based hydrosilylation catalysts for curing the present composition are platinum metal, platinum compounds and platinum complexes. Representative platinum compounds include chloroplatinic acid, chloroplatinic acid hexahydrate, platinum dichloride, and complexes of such compounds containing low molecular weight vinyl containing organosiloxanes.

The platinum group metal containing catalyst may be added to the present composition in an amount equivalent to as little as 0.001 part by weight of elemental platinum group metal, per one million parts (ppm) of the composition. Preferably, the concentration of platinum group metal in the composition is that capable of providing the equivalent of at least 1 part per million of elemental platinum group metal. A catalyst concentration providing the equivalent of about 3-50 parts per million of elemental platinum group metal is generally the amount preferred.

To obtain a longer working time or “pot life”, the activity of hydrosilylation catalysts under ambient conditions can be retarded or suppressed by addition of a suitable inhibitor. Known platinum group metal catalyst inhibitors include the acetylenic compounds disclosed in U.S. Pat. No. 3,445,420. Acetylenic alcohols such as 2-methyl-3-butyn-2-ol and 1-ethynyl-2-cyclohexanol constitute a preferred class of inhibitors that suppress the activity of a platinum-based catalyst at 25° C. Compositions containing these catalysts typically require heating at temperatures of 70° C. or above to cure at a practical rate. Room temperature cure is typically accomplished with such systems by use of a two-part system in which the crosslinker and inhibitor are in one of the two parts and the platinum is in the other part. The amount of platinum is increased to allow for curing at room temperature.

Compositions in accordance with the present invention contain one or more finely divided, reinforcing fillers (d) such as high surface area fumed and precipitated silicas and to a degree calcium carbonate or additional non-reinforcing fillers such as crushed quartz, diatomaceous earths, barium sulphate, iron oxide, titanium dioxide and carbon black, talc, wollastonite. Other fillers which might be used alone or in addition to the above include aluminite, calcium sulphate (anhydrite), gypsum, calcium sulphate, magnesium carbonate, clays such as kaolin, aluminium trihydroxide, magnesium hydroxide (brucite), graphite, copper carbonate, e.g. malachite, nickel carbonate, e.g. zarachite, barium carbonate, e.g. witherite and/or strontium carbonate e.g. strontianite

Aluminium oxide, silicates from the group consisting of olivine group; garnet group; aluminosilicates; ring silicates; chain silicates; and sheet silicates. The olivine group comprises silicate minerals, such as but not limited to, forsterite and Mg₂SiO₄. The garnet group comprises ground silicate minerals, such as but not limited to, pyrope; Mg₃Al₂Si₃O₁₂; grossular; and Ca₂Al₂Si₃O₁₂. Aluminosilicates comprise ground silicate minerals, such as but not limited to, sillimanite; Al₂SiO₅; mullite; 3Al₂O₃.2SiO₂; kyanite; and Al₂SiO₅. The ring silicates group comprises silicate minerals, such as but not limited to, cordierite and Al₃(Mg,Fe)₂[Si₄AlO₁₈]. The chain silicates group comprises ground silicate minerals, such as but not limited to, wollastonite and Ca[SiO₃].

The sheet silicates group comprises silicate minerals, such as but not limited to, mica; K₂Al₁₄[Si₆Al₂O₂₀](OH)₄; pyrophillite; Al₄[Si₈O₂₀](OH)₄; talc; Mg₆[Si₈O₂₀](OH)₄; serpentine for example, asbestos; Kaolinite; Al₄[Si₄O₁₀](OH)₈; and vermiculite.

In addition, a surface treatment of the filler(s) may be performed, for example with a fatty acid or a fatty acid ester such as a stearate, or with organosilanes, organosiloxanes, or organosilazanes hexaalkyl disilazane or short chain siloxane diols to render the filler(s) hydrophobic and therefore easier to handle and obtain a homogeneous mixture with the other sealant components. The surface treatment of the fillers makes the ground silicate minerals easily wetted by the silicone polymer. These surface modified fillers do not clump, and can be homogeneously incorporated into the silicone polymer. This results in improved room temperature mechanical properties of the uncured compositions. Furthermore, the surface treated fillers give a lower conductivity than untreated or raw material.

The proportion of such fillers when employed will depend on the properties desired in the elastomer-forming composition and the cured elastomer. Usually the filler content of the composition will reside within the range from about 5 to about 500 parts by weight per 100 parts by weight of the high molecular weight organopolysiloxane polymer (a) (i). A range of from 50 to 400 parts by weight per 100 parts by weight of the polymer (a) is preferred.

Components (e) and (f) are an organic polymer containing terminal and/or pendent silyl groups selected from polyurethane, a polyether, (meth)acrylate and a saturated hydrocarbon polymer such as polyisobutylene and/or and or mixtures thereof. The silyl groups in component (e) must contain reactive groups which will participate in the composition cure with the reactive groups of polymer (a) (i) and the remaining ingredients, e.g. it must contain one or more —OH groups or hydrolysable groups when (a) has like terminal groups and similarly component (f) must contain at least one unsaturated group when the silyl end groups in (a) also contain these. In both components (e) and (f) the silyl groups are preferably either all terminal groups or all pendent groups attached to the polymer backbone but may be a mixture of both.

Any suitable silylated polyurethane may be used as component (e) or (f). However polyurethanes synthesized from polyols reacted with isocyanatosilanes are particularly preferred. Suitable polyols include polyoxyalkylene diols such as, for example, polyoxyethylene diol, polyoxypropylene diol, and polyoxybutylene diol, polyoxyalkylene triols, polytetramethylene glycols, polycaprolactone diols and triols, and the like. Other polyol compounds, including tetraols such as pentaerythritol, sorbitol, mannitol and the like may alternatively be used. Preferred polyols used in the present invention are polyoxypropylene diol with equivalent weights in the range of from about 500 to about 50,000; preferably, between about 10,000 and 30,000. Mixtures of polyols of various structures, molecular weights and/or functionalities may also be used.

Suitable polyurethane prepolymer intermediates include polyurethane polymers that can be prepared by the chain extension reaction of polyols with diisocyanates. Any suitable diisocyanates may be utilised. Examples include, for example, 2,4-toluene diisocyanate; 2,6-toluene diisocyanate; 4,4′-diphenyl-methanediisocyanate; isophorone diisocyanate; dicyclohexylmethane-4,4′ diisocyanate; various liquid diphenylmethanediisocyanates containing a branch or a mixture of 2,4- and 4,4′ isomers and the like, and mixtures thereof.

Silane endcappers are chosen in accordance with the end groups required for components (e) and (f) respectively. For example in the case of component (e) silane endcappers which may be utilised in the preparation of said suitable and silyl terminated polyurethanes may be represented by the general formula:

R″-R—Si(X)n(R′)3-n

wherein R is a divalent organic group; R′ is alkyl or aryl, preferably having from 1 to 8 carbon atoms, X is an alkoxy, an —OH or an unsaturated group having from 2 to 8 carbon atoms; and n is an integer from 1 to 3. Group R″ is an organo-functional group, which can react with either isocyanato or hydroxyl terminated polymers, such as isocyanato, primary or secondary amino, mercapto, or ureido functional groups. When X is an unsaturated group, X may be the same or different and is selected from the alternatives discussed above for polymer (a). Alkenyl groups, e.g. vinyl groups are particularly preferred.

Any suitable silyl terminated polyether may be utilised as components (e) and (f). These are usually prepared by reacting an unsaturated group-containing polyether oligomer with a reactive silicon group-containing compound in the presence of a Group VIII transition metal catalyst, such as chloroplatinic acid. The polyether may for example be obtained by the ring-opening addition polymerization of a substituted or unsubstituted C₂₋₁₂ epoxy compound such as an alkylene oxide, e.g. ethylene oxide, propylene oxide, [alpha]-butylene oxide, [beta]-butylene oxide, hexene oxide, cyclohexene oxide, styrene oxide and [alpha]-methylstyrene oxide or an alkyl, allyl or aryl glycidyl ether, e.g. methyl glycidyl ether, ethyl glycidyl ether, isopropyl glycidyl ether, butyl glycidyl ether, allyl glycidyl ether and phenyl glycidyl ether, using as polymerization initiator a dihydric or polyhydric alcohol, e.g. ethylene glycol, propylene glycol, butanediol, hexamethylene glycol, methallyl alcohol, hydrogenated bisphenol A, neopentyl glycol, polybutadienediol, diethylene glycol, triethylene glycol, polyethylene glycol, polypropylene glycol, polypropylene triol, polypropylenetetraol, dipropylene glycol, glycerol, trimethylolmethane, trimethylolpropane and pentaerythritol, or a hydroxyl-containing oligomer in the presence of a suitable catalyst.

The introduction of an unsaturated group into a hydroxy-terminated polyether oligomer can be achieved by any known method, for example by the method comprising reacting the hydroxy-terminated polyether oligomer with an unsaturated group-containing compound through bonding via e.g. ether linkages, ester linkages, or carbonate bonding. More specifically, examples of the organic polymer (A) include polyoxyalkylene polymers such as polyoxyethylene, polyoxypropylene, polyoxybutylene, polyoxytetramethylene, polyoxyethylene-polyoxypropylene copolymer, and polyoxyprolylene-polyoxybutylene copolymer. Preferably the polyoxyalkylene based blocks, are bonded with silanes or siloxanes via a hydrosilylation reaction. Polyoxyalkylene blocks suitable for the current invention comprise a linear predominantly oxyalkylene polymer comprised of recurring oxyalkylene units, of the formula (—CₙH₂ₙ—O—) illustrated by the average formula (—CₙH₂ₙ—O—)_{y} wherein n is an integer from 2 to 4 inclusive and y is an integer of at least four. The number average molecular weight of each polyoxyalkylene polymer block may range from about 300 to about 50,000. Moreover, the oxyalkylene units are not necessarily identical throughout the polyoxyalkylene monomer, but can differ from unit to unit. A polyoxyalkylene block, for example, can be comprised of oxyethylene units, (—C₂H₄—O—); oxypropylene units (—C₃H₆—O—); or oxybutylene units, (—C₄H₈—O—); or mixtures thereof. Preferably the polyoxyalkylene polymeric backbone consists essentially of oxypropylene units.

Other polyoxyalkylene blocks may include for example: units of the structure—

—[—Re—O—(—Rf—O—)h—Pn—CRg2-Pn—O—(—Rf—O—)q-Re]—

in which Pn is a 1,4-phenylene group, each R^{e} is the same or different and is a divalent hydrocarbon group having 2 to 8 carbon atoms, each R^{f} is the same or different and, is, an ethylene group propylene group, or isopropylene group each R^{g} is the same or different and is a hydrogen atom or methyl group and each of the subscripts h and q is a positive integer in the range from 3 to 30. The silyl terminal group contains either an —OH group or an unsaturated group of the type previously discussed above.

Any suitable silyl terminated (meth)acrylate polymer may be utilised as component (e) and (f). These may include for example (meth)acrylate polymers obtained by radical polymerization of the monomers such as ethyl(meth)acrylate and butyl(meth)acrylate; vinyl polymers obtained by radical polymerization of (meth)acrylate monomers. Alternatively, silyl terminated saturated hydrocarbon polymers such as polyisobutylene, hydrogenated polyisoprene, and hydrogenated polybutadiene may alternatively be utilised as (e). The silyl terminal group contains either an —OH group or an unsaturated group of the type previously discussed above.

In the case of component (f) each unsaturated group may be the same or different and is selected from alkenyl terminated e.g. ethenyl terminated, propenyl terminated, allyl terminated (CH₂═CHCH₂—)) or they may be terminated with acrylic or alkylacrylic such as CH₂═C(CH₃)—CH₂— groups. Representative, non-limiting examples of the alkenyl groups are shown by the following structures; H₂C═CH—, H₂C═CHCH₂—, H₂C═C(CH₃)CH₂—, H₂C═CHCH₂CH₂—, H₂C═CHCH₂CH₂CH₂—, and H₂C═CHCH₂CH₂CH₂CH₂—. Representative, non-limiting examples of alkynyl groups are shown by the following structures; HCEC-, HC≡CCH₂—, HC≡CC(CH₃)—, HC≡CC(CH₃)₂—, HC≡CC(CH₃)₂CH₂— Alternatively, the unsaturated organic group can be an organofunctional hydrocarbon such as an acrylate, methacrylate. Alkenyl groups, e.g. vinyl groups are particularly preferred.

Optionally component (e) or (f) may be mixed with one or more appropriate plasticiser(s) and/or extender(s) or a combination thereof (hereafter referred to as component (g)). Component (g), when present, may be introduced into component (e) prior to introduction into the composition or may be added directly into the composition. Component (g) must be substantially miscible and preferably totally miscible with component (e) or (f) dependent on which is present but need not be miscible with component (a) (i). Preferably, when present, component (g) is miscible with component (a) (ii) but this is not essential. Indeed if a suitable candidate is identified component (a) (ii) and (g) may be the same although this not preferred. Examples of component (g) include, for the sake of example, each of the following alone or in combination with others from the list: dialkyl phthalates wherein the alkyl group may be linear and/or branched and contains from six to 20 carbon atoms such as dioctyl, dihexyl, dinonyl, didecyl, diallanyl and other phthalates; adipate, azelate, oleate and sebacate esters, polyols such as ethylene glycol and its derivatives, organic phosphates such as tricresyl phosphate and/or triphenyl phosphates.

Other ingredients which may be included in the compositions include but are not restricted to adhesion promoters, pigments, UV stabilizers, fungicides and/or biocides and the like (which may suitably by present in an amount of from 0 to 0.3% by weight), water scavengers, (typically the same compounds as those used as cross-linkers or silazanes). It will be appreciated that some of the additives are included in more than one list of additives. Such additives would then have the ability to function in all the different ways referred to.

Any suitable adhesion promoter(s) may be incorporated in a sealant composition in accordance with the present invention. These may include for example alkoxy silanes such as aminoalkylalkoxy silanes, epoxyalkylalkoxy silanes, for example, 3-glycidoxypropyltrimethoxysilane and, mercapto-alkylalkoxy silanes and γ-aminopropyl triethoxysilane, reaction products of ethylenediamine with silylacrylates. Isocyanurates containing silicon groups such as 1,3,5-tris(trialkoxysilylalkyl) isocyanurates may additionally be used. Further suitable adhesion promoters are reaction products of epoxyalkylalkoxy silanes such as 3-glycidoxypropyltrimethoxysilane with amino-substituted alkoxysilanes such as 3-aminopropyltrimethoxysilane and optionally alkylalkoxy silanes such as methyl-trimethoxysilane, epoxyalkylalkoxy silane, mercaptoalkylalkoxy silane, and derivatives thereof.

The mixture of a silicone polymerized in an extender with an —OH functional or hydrolysable functional silyl terminated organic polymer or one or more unsaturated silyl terminated organic polymers such as a silyl terminated polyether (STPE) in a sealant formulation is leading to a curable and paintable silicone hybrid sealant. In the case of moisture curable systems, the use of two moisture curable polymer is leading after cure to an interpenetrated polymer network exhibiting superior mechanical properties over conventional mixture of immiscible polymers. The cure material is showing good paintability with water and solvent based paints, provided that the overall content in siloxane is staying below 10 wt %. Tensile pieces are showing an elongation up to 200% with a modulus at 100% of strain inferior to 0.5 MPa. The use of a high molecular weight silicone polymerized in an organic extender is required to achieve both excellent mechanical properties combined to an excellent paintability

A composition in accordance with the present invention may be prepared by mixing the constituents of the composition employing any suitable mixing equipment. Optional constituents may be added as required. For example preferred one part, moisture curable compositions may be made by mixing together the diluted polymer having hydroxyl or hydrolysable groups and filler used, and mixing this with a pre-mix of the cross-linker and catalyst. UV-stabilisers pigments and other additives may be added to the mixture at any desired stage. If required additional plasticiser and/or extender may be blended with the other composition ingredients after polymerisation.

After mixing, the compositions may be stored under substantially anhydrous conditions, for example in sealed containers, until required for use.

The polymerisation in the presence of the plasticiser and/or extender gives several advantages with respect to sealant formulations. In respect to rheology, the increase in polymer chain length enabled due to the presence of the plasticiser and/or extender compensates for the amount of plasticiser and/or extender present in the diluted sealant and as such the viscosity of the diluted polymer is significantly higher than it would be if the plasticiser and/or extender had been added to a standard polymer used in sealant formulations currently having for example a viscosity of 80000 to 100 000 mPa·s at 25° C. The lower modulus of the resulting sealant additionally means that more movement is possible in the joint being sealed, to the extent that even if plasticiser and/or extender loss occurs, the effective modulus caused by the presence of high molecular weight polymers which may be prepared in accordance with the process of the present invention is able to compensate for stress caused to the seal due to shrinkage. The product of the process of the present invention gives superior processing advantages due to the comparatively low viscosity of the diluted polymer when considering the molecular weight of the polymer.

The formulation is preferably a moisture curing sealant formulation but can also be an addition curing composition for any application, but the result of the crosslinking should involve the in-situ coupling of the two non miscible polymers (a) and (e). This reaction is required to form an interpenetrating polymer network that is a prerequisite to obtain good mechanical and adhesion properties.

In accordance with the present invention there is provided a moisture curable composition capable of cure to an elastomeric body obtainable by:
(I) polymerising an organopolysiloxane containing monomer or oligomer polymer in the presence of one or more organic plasticiser(s) and/or one or more organic extender(s) or a mixture thereof via a polycondensation, ring opening, polyaddition or chain extension reaction pathway, to form a diluted polymer product (a) comprising an organopolysiloxane chain having a number average molecular weight (Mₙ) of at least 100,000 and terminal groups selected from either silanol and/or other hydrolysable groups; or unsaturated groups;
(II) mixing the diluted polymer product (a) with
   (b) a suitable amount of one or more suitable cross-linkers for cross-linking (a)
   (c) a suitable amount of catalyst
   (d) one or more fillers; and
   either (e) or (f), selected to chemically interact with (a) and (b), wherein
   (e) is one or more organic polymers having terminal and/or pendent silyl groups containing —OH functional groups or hydrolysable functional groups, and
   (f) is one or more organic polymers having terminal and/or pendent silyl groups containing one or more unsaturated groups, selected in accordance with the terminal groups of (a); characterised in that in that the composition comprises up to 8% by weight of the high molecular weight organopolysiloxane polymer in component (a).

The composition in accordance with the present invention is preferably a one or two part organopolysiloxane sealant composition. A two part composition comprises in the first part diluted polymer and filler (when required) and in the second part catalyst and cross-linker are provided for mixing in an appropriate ratio (e.g. from 1:1 to 10:1) immediately prior to use. The optional additives discussed above may be provided in either part 1 or part 2 of the part composition but are preferably added in part two.

The compositions can be prepared by mixing the ingredients employing any suitable mixing equipment. Other components may be added as necessary. For example preferred one part, moisture curable compositions may be made by mixing together the extended polysiloxane having hydroxyl or hydrolysable groups and any organosilicon plasticizer or filler used, and mixing this with a pre-mix of the crosslinker and catalyst. UV-stabilisers pigments and other additives may be added to the mixture at any desired stage.

After mixing, the compositions may be stored under substantially anhydrous conditions, for example in sealed containers, until required for use.

Compositions according to this aspect are stable in storage but cure on exposure to atmospheric moisture and may be employed in a variety of applications, for example as coating, caulking and encapsulating materials. They are, however, particularly suitable for sealing joints, cavities and other spaces in articles and structures which are subject to relative movement. They are thus particularly suitable as glazing sealants and for sealing building structures where the visual appearance of the sealant is important.

Thus in a further aspect, the invention provides a method of sealing a space between two units, said method comprising applying a composition as described above and causing or allowing the composition to cure. Suitable units include glazing structures or building units as described above and these form a further aspect of the invention.

In a further embodiment of the present invention there is provided a method of producing a cured silicone elastomer with a surface coated with a hardened protective coating comprising, exposing a composition as hereinbefore described to moisture until a cured elastomeric surface is obtained and a homogeneous dull surface develops, thereafter applying a protective coating composition, hardenable at ambient conditions, over at least a portion of the cured elastomeric surface where the protective coating composition wets the surface to which it is applied and produces an essentially flaw-free film and, thereafter, allowing the protective coating composition to harden.

The compositions are preferably room temperature vulcanisable compositions in that they cure at room temperature without heating although heating may be used to accelerate cure if appropriate.

Preferably the diluted polymer in the composition of the present invention is obtainable by any suitable polymerisation process provided the polymer is mixed with the extender during the polymerisation process. Preferred routes to the preparation of said polymer are by the following routes
(i) polycondensation
(ii) ring opening/equilibrium
(iii) polyaddition
(iv) chain extension
   wherein where required polymers resulting from the above polymerisation routes may be end-capped to provide the required hydrolysable end-groups.

In accordance with the present invention there is provided a method of preparing a moisture curable composition capable of cure to an elastomeric body by:
(I) polymerising an organopolysiloxane containing monomer or oligomer polymer in the presence of one or more organic plasticiser(s) and/or one or more organic extender(s) or a mixture thereof via a polycondensation, ring opening, polyaddition or chain extension reaction pathway, to form a diluted polymer product; (a) comprising an organopolysiloxane chain having a number average molecular weight (Mn) of at least 100,000 and terminal groups selected from either silanol and/or other hydrolysable groups; or unsaturated groups;
(II) mixing the diluted polymer product (a) with
   (b) a suitable amount of one or more suitable cross-linkers for cross-linking (a)
   (c) a suitable amount of catalyst
   (d) one or more fillers; and
   either (e) or (f), selected to chemically interact with (a) and (b), wherein
   (e) is one or more organic polymers having terminal and/or pendent silyl groups containing —OH functional groups or hydrolysable functional groups, and
   (f) is one or more organic polymers having terminal and/or pendent silyl groups containing one or more unsaturated groups, selected in accordance with the terminal groups of (a); characterised in that in that the composition comprises up to 8% by weight of the high molecular weight organopolysiloxane polymer in component (a).

The resulting composition is curable at room temperature in the presence of moisture in the air.

### Polycondensation

The polymerisation of multiple monomers and/or oligomers with the elimination of low molecular weight by-product(s) such as water, ammonia or methanol etc). Polycondensation type polymerisation reactions are most generally linked to the interaction of compounds having hydroxyl and/or hydrolysable end groups which can interact with the release of e.g. water or methanol or the like. A selection of condensation reactions which may be additionally utilised for the polymerisation process between monomers and/or oligomers in accordance with the present invention include:
1) the condensation of organohalosilyl groups with an organoalkoxysilyl groups,
2) the condensation of organohalosilyl groups with organoacyloxysilyl groups,
3) the condensation of organohalosilyl groups with organosilanols,
4) the condensation of organohalosilyl groups with silanolates,
5) the condensation of organo-hydrosilyl groups with organosilanol groups
6) the condensation of organoalkoxysilyl groups with organoacyloxysilyl groups
7) the condensation of organoalkoxysilyl groups with organosilanol groups;
8) the condensation of organoaminosilyl groups with organosilanols,
9) the condensation of organoacyloxysilyl groups silanolate groups
10) the condensation of organoacyloxysilyl groups with organosilanols,
11) the condensation of organooximosilyl groups with organosilanol groups
12) the condensation of organoenoxysilyl groups with organosilanols,
13) The condensation of a siloxane compound comprising one or more hydrosilane functional groups with a siloxane compounds containing at least one alkoxysilane functional group, generating hydrocarbon by-products.

Any of the above condensation type reactions may be used for the polymerisation of monomer(s)/oligomer(s) and as such may be the basis for the polymerisation process in accordance with the present invention.

One preferred method for the polymerisation process is the polymerisation of straight chain and/or branched organopolysiloxanes of formula (1a):

R′aSiO4-a/2 (1a)

wherein each R′ is either hydrogen or R⁵ as hereinbefore described. Preferably the polydiorganosiloxanes are polydialkylsiloxanes, most preferably polydimethylsiloxanes. They are preferably substantially linear materials, which are end-blocked with a siloxane group of the formula R″₃SiO_{1/2}, wherein each R″ is the same or different and is R′ or a condensable group. Any suitable combination of condensable end groups may be used for the polymerisation process of the present invention (i.e. the condensable groups chosen must be able to undergo a condensation reaction together in order to polymerize). Preferably at least one R″ group is a hydroxyl or hydrolysable group. Typically the condensable groups used as monomer/oligomer end-groups are as indicated above but may be any groups which will participate in a polycondensation of the monomer/oligomer in the presence of the extender in accordance with the present invention.

Starting materials for the condensation reaction of silanol containing siloxanes are organopolysiloxane oligomers having silicon-bonded hydroxyl groups or hydrolysable groups such as alkoxy groups, which may form silanol groups in situ. Preferably the starting materials have a viscosity of between 10 mPa·s and 5000 mPa·s. Some of the starting materials may comprise non-hydrolysable end-groups.

Many of the above processes require the presence of catalyst. Any suitable polycondensation catalyst may be utilised. These include any of the catalysts described above for the condensation cure of the composition in accordance with the present invention, protic acids, Lewis acids, organic and inorganic bases, metal salts and organometallic complexes. Lewis acid catalysts. (a “Lewis acid” is any substance that will take up an electron pair to form a covalent bond). suitable for the polymerisation in the present invention include, for example, boron trifluoride FeCl₃, AlCl₃, ZnCl₂, and ZnBr₂.

More preferred are condensation specific catalysts such as acidic condensation catalysts of the formula R²⁰SO₃H in which R²⁰ represents an alkyl group preferably having from 6 to 18 carbon atoms such as for example a hexyl or dodecyl group, an aryl group such as a phenyl group or an alkaryl group such as dinonyl- or didoecyl-naphthyl. Water may optionally be added. Preferably R²⁰ is an alkaryl group having an alkyl group having from 6 to 18 carbon atoms such as dodecylbenzenesulphonic acid (DBSA). Other condensation specific catalysts include n-hexylamine, tetramethylguanidine, carboxylates of rubidium or caesium, hydroxides of magnesium, calcium or strontium and other catalysts as are mentioned in the art, e.g. in GB patent specifications 895091, 918823 and EP 0382365. Also preferred are catalysts based on phosphonitrile chloride, for example those prepared according to U.S. patent specifications 3,839,388 and 4,564,693 or EP application 215 470 and phosphonitrile halide ion based catalysts, as described in GB2252975, having the general formula [X³ (PX³₂═N)ₓPX³₃]⁺[M²X³₍ᵥ₋ₜ₊₁₎R^{III}ₜ]⁻, wherein X³ denotes a halogen atom, M² is an element having an electronegativity of from 1.0 to 2.0 according to Pauling's scale, R^{III} is an alkyl group having up to 12 carbon atoms, s has a value of from 1 to 6, v is the valence or oxidation state of M² and t has a value of from 0 to v−1.

Alternatively the catalyst may comprise an oxygen-containing chlorophosphazene containing organosilicon radicals having the following general formula:

Z1-PCI2=N(−PCI2=N)n−PCI2-O

in which
Z¹ represents an organosilicon radical bonded to phosphorus via oxygen, a chlorine atom or the hydroxyl group and
n represents 0 or an integer from 1 to 8. The catalyst may also comprise condensation products of the above and/or tautomers thereof (the catalyst exists in a tautomeric form when Z¹ is a hydroxyl group).

A further alternative catalyst which might be used as the catalyst in the present invention is any suitable compound providing a source of anions comprising at least one quadri-substituted boron atom and protons capable of interaction with at least one silanol group as defined in WO 01/79330.

The activity of the catalyst is preferably quenched by using a neutralizing agent which reacts with the catalyst to render it non-active. Typically in the case of the acid type condensation catalysts the neutralizing agent is a suitable base such as an amine such as a mono/di and trialkanolamines for example monoethanolamine (MEA) and triethanolamine (TEA). In the case of systems using a DBSA catalyst alternative quenching means include aluminosilicate zeolite materials that were found to absorb DBSA and leave a stable polymer. In most cases catalyst residues remain in the polymer product or where appropriate may be removed by filtration or alternative methods. In the case of phosphazene based catalysts when the desired viscosity has been reached, the viscosity of the organosilicon compound obtained in the process can be kept constant by a procedure in which the catalyst used, or a reaction product which has been formed from this catalyst by reaction with organosilicon compound to be subjected to condensation and/or equilibration and likewise promotes the condensation and/or equilibration of organosilicon compounds, is inhibited or deactivated by addition of inhibitors or deactivators which have been employed to date in connection with phosphazenes, for example, triisononylamine, n-butyllithium, lithium siloxanolate, hexamethyldisilazane and magnesium oxide.

Where appropriate any suitable end-blocking agent, which halts the polymerization reaction and thereby limits the average molecular weight, may be used to introduce the silyl end groups described above as X² and X¹.

### Equilibration/Ring Opening

The starting material for equilibration polymerisation processes such as ring-opening polymerisation is a cyclosiloxane (also known as a cyclic siloxane). Cyclic siloxanes which are useful are well known and commercially available materials. They have the general formula (R²¹SiO)ₘ, wherein each R²¹ is R′ is as hereinbefore described and m denotes an integer with a value of from 3 to 12. R²¹ can be substituted, e.g. by halogen such as fluorine or chlorine. The alkyl group can be, for example, methyl, ethyl, n-propyl, trifluoropropyl, n-butyl, sec-butyl, and tert-butyl. The alkenyl group can be, for example, vinyl, allyl, propenyl, and butenyl. The aryl and aralkyl groups can be, for example, phenyl, tolyl, and benzoyl. The preferred groups are methyl, ethyl, phenyl, vinyl, and trifluoropropyl. Preferably at least 80% of all R²¹ groups are methyl or phenyl groups, most preferably methyl. Preferably the average value of m is from 3 to 6. Examples of suitable cyclic siloxanes are octamethylcyclotetrasiloxane, hexamethylcyclotrisiloxane, decamethylcyclopentasiloxane, cyclopenta(methylvinyl)siloxane, cyclotetra(phenylmethyl)siloxane, cyclopentamethylhydrosiloxane and mixtures thereof. One particularly suitable commercially available material is a mixture of comprising octamethylcyclotetrasiloxane and decamethylcyclopentasiloxane. Typically moisture is present in the monomers. The water present acts as an end-blocker by forming OH end groups on the polymers.

Any suitable catalyst may be used. These include alkali metal hydroxides such as lithium hydroxide, sodium hydroxide, potassium hydroxide or caesium hydroxide, alkali metal alkoxides or complexes of alkali metal hydroxides and an alcohol, alkali metal silanolates such as potassium silanolate caesium silanolate, sodium silanolate and lithium silanolate or trimethylpotassium silanolate. Other catalysts which might be utilised include the catalyst derived by the reaction of a tetra-alkyl ammonium hydroxide and a siloxane tetramer and the boron based catalysts as hereinbefore described.

Catalysts which are most preferred for the equilibrium type of reaction however are phosphonitrile halides, phosphazene acids and phosphazene bases as hereinbefore described.

Where required the polymer obtained may be end-blocked as a means of regulating the molecular weight of the polymer and/or to add functionality. Suitable end-blocking agents include silanes having 1 group capable of reacting with the terminal groups of the resulting polymeric constituent prepared in the diluted polymer. Preferred silanes which may be utilised as end-blockers however for the purpose of the present invention. They are used to introduce the hydroxyl and hydrolysable groups depicted above as X² and X¹.

### Polyaddition

For the sake of this specification a “polyaddition” or (“addition polymerisation”) process is a polymerisation process whereby unlike in a condensation reaction no by-products such as water or alcohols are generated from the monomeric and oligomeric co-reactants during polymerisation. A preferred addition polymerisation route is a hydrosilylation reaction between an unsaturated organic group e.g. an alkenyl or alkynyl group and an Si—H group in the presence of a suitable catalyst.

Typically the polyaddition route is utilised to form block copolymers by reacting
(a) an organopolysiloxane with:
(b) one or more
   (i) organopolysiloxane polymer(s) or
   (ii) organic polymer(s)
      via an addition reaction pathway in the presence of the extender, and a suitable catalyst and optionally an end-blocking agent; and where required quenching the polymerisation process.

The organopolysiloxane (a) must contain substituents such that it is capable of undergoing an appropriate addition reaction with polymers (b) (i) or (ii). The preferred addition reaction is a hydrosilylation reaction between an unsaturated group and an Si—H group.

Organopolysiloxane monomer (a) is preferably in the form of a straight chain and/or branched organopolysiloxane comprising units of formula (1a)

R′ₐSiO_{4-a/2} (1a)

wherein each R′ is as hereinbefore described. Preferably the polydiorganosiloxanes are polydialkylsiloxanes, most preferably polydimethylsiloxanes. When the organopolysiloxane or silane (a) is an organopolysiloxane monomer, said organopolysiloxane monomer must have at least one group which is reactable with at least two groups, typically the terminal groups, of (b) (i) or (ii) via an addition reaction process. Preferably organopolysiloxane (a) (i) comprises at least one Si—H per molecule, preferably at least two Si—H groups per molecule. Preferably organopolysiloxane (a) (i) is end-blocked with a siloxane group of the formula H(R″)₂SiO_{1/2}, wherein each R″ is a hydrocarbon or substituted hydrocarbon group, most preferably an alkyl group. Preferably organopolysiloxane (a) has a viscosity of between 10 mPa·s and 5000 mPa·s at 25° C.

Organopolysiloxane polymer (b) (i) is preferably a straight chain and/or branched organopolysiloxane comprising units of formula (1b)

R′″ₐSiO_{4-a/2} (1b)

wherein each R′″ may be the same or different and denotes a hydrocarbon group having from 1 to 18 carbon atoms, a substituted hydrocarbon group having from 1 to 18 carbon atoms or a hydrocarbonoxy group having up to 18 carbon atoms and a has, on average, a value of from 1 to 3, preferably 1.8 to 2.2. Preferably no R′″ groups may be hydrogen groups. Preferably each R′″ is the same or different and are exemplified by, but not limited to alkyl groups such as methyl, ethyl, propyl, butyl, pentyl, hexyl, heptyl, octyl, undecyl, and octadecyl; cycloalkyl such as cyclohexyl; aryl such as phenyl, tolyl, xylyl, benzyl, and 2-phenylethyl; and halogenated hydrocarbon groups such as 3,3,3-trifluoropropyl, 3-chloropropyl, and dichlorophenyl.

Organopolysiloxane polymer (b) (i) may comprise any suitable organopolysiloxane polymeric backbone but is preferably linear or branched, and comprises at least one, preferably at least two substituent groups which will react with the aforementioned groups in the organopolysiloxane or silane (a) via an addition reaction pathway. Preferably each substituent group of polymer (b) (i) is a terminal group. When the organopolysiloxane or silane (a) comprises at least one Si—H group, the preferred substituent groups on organopolysiloxane polymer (b) (i), which are designed to interact with the Si—H groups, are preferably unsaturated groups (e.g. alkenyl terminated e.g. ethenyl terminated, propenyl terminated, allyl terminated (CH₂═CHCH₂—)) or terminated with acrylic or alkylacrylic such as CH₂═C(CH₃)—CH₂— groups Representative, non-limiting examples of the alkenyl groups are shown by the following structures; H₂C═CH—, H₂C═CHCH₂—, H₂C═C(CH₃)CH₂—, H₂C═CHCH₂CH₂—, H₂C═CHCH₂CH₂CH₂—, and H₂C═CHCH₂CH₂CH₂CH₂—. Representative, non-limiting examples of alkynyl groups are shown by the following structures; HCEC-, HCECCH₂—, HCECC(CH₃)—, HCECC(CH₃)₂—, HCECC(CH₃)₂CH₂— Alternatively, the unsaturated organic group can be an organofunctional hydrocarbon such as an acrylate, methacrylate and the like such as alkenyl an/or alkynyl groups. Alkenyl groups are particularly preferred.

A composition in accordance with the present invention may be prepared by mixing the constituents of the composition employing any suitable mixing equipment. Optional constituents may be added as required. For example preferred one part, moisture curable compositions may be made by mixing together the diluted polymer having hydroxyl or hydrolysable groups and filler used, and mixing this with a pre-mix of the cross-linker and catalyst. UV-stabilisers pigments and other additives may be added to the mixture at any desired stage. If required additional plasticiser and/or extender may be blended with the other composition ingredients after polymerisation.

After mixing, the compositions may be stored under substantially anhydrous conditions, for example in sealed containers, until required for use.

Compositions according to the invention may be formulated as single part formulations which are stable in storage but cure on exposure to atmospheric moisture and may be employed in a variety of applications, for example as coating, caulking and encapsulating materials. They are, however, particularly suitable for sealing joints, cavities and other spaces in articles and structures which are subject to relative movement. They are thus particularly suitable as glazing sealants and for sealing building structures where the visual appearance of the sealant is important.

Thus in a further aspect, the invention provides a method of sealing a space between two units, said method comprising applying a composition as described above and causing or allowing the composition to cure. Suitable units include glazing structures or building units as described above and these form a further aspect of the invention.

The present invention will now be described in detail by way of the following Examples in which all viscosity measurements were taken at 25° C. using a recording Brookfield viscometer according to ASTM D-3236 test method unless otherwise indicated. Molecular weight was measured by triple detection size exclusion chromatography in toluene using polystyrene standards. The mixture of OH terminated polydimethylsiloxane of a varying molecular weights in HYDROSEAL® G250H, was prepared in accordance with the invention, i.e. the polymer was prepared from respective monomers and/or oligomers in the presence of HYDROSEAL® G250H as described above and in WO2006/106362 which is incorporated herein by reference.

### EXAMPLE 1

269.7 g of a 60%/40% weight mixture of OH terminated polydimethylsiloxane of a molecular weight ca 160,000 in HYDROSEAL® G250H a hydrotreated mineral oil cut (n-para 7% iso-para 51% and naphthenic 42%), which is sold by Total., 269.7 g of silyl terminated polyurethane sold under the trade name Desmoseal® S XP 2636 by Bayer, 662.3 g of alkyl (C7-C8-C9) benzyl phthalate sold under the Trade name Santicizer® 261 by Ferro and 15 g of bis(1-octyloxy-2,2,6,-tetramethyl-4-piperidyl) sebacate were incorporated into a mixer and mixed for 2 minutes at room temperature. Thereafter, 755.2 g of a fatty acid treated ground calcium carbonate sold under the Trade name Mickart® AC supplied by La Provencale was added and mixed for 5 minutes at room temperature. 944.1 g of an ultrafine, stearic acid treated precipitated calcium carbonate sold as Socal® 312N supplied by Solvay was then added and mixed for 5 minutes at room temperature. A quantity of 68.9 g of methyl trimethoxy silane was added to the compound and mixed for 5 minutes. A dynamic vacuum was applied for 10 minutes prior to the addition of 3 g of [3-(2-aminoethyl)aminopropyl]trimethoxysilane and 12 g of a premix 80/20 by weight of diisopropoxy-bis ethylacetoacetato titanate and methyl trimethoxy silane. The compound was first mixed for 5 minutes at room temperature then was mixed for 5 minutes under a dynamic vacuum. The sealant was then extruded in cartridges with the help of a press on the mixing pot and stored at room temperature.

### EXAMPLE 2

330.0 g of a 60%/40% weight mixture of OH terminated polydimethylsiloxane of a molecular weight ca 160,000 in HYDROSEAL® G250H, 264.0 g of Desmoseal S XP 2636, 648.0 g of Santicizer® 261 and 15 g of bis(1-octyloxy-2,2,6,-tetramethyl-4-piperidyl) sebacate were incorporated into a mixer and mixed for 2 minutes at room temperature. Thereafter, 741.0 g of Mickart® AC was added and mixed for 5 minutes at room temperature. 924.0 g Socal® 312N was then added and mixed for 5 minutes at room temperature. A quantity of 66.0 g of methyl trimethoxy silane was added to the compound and mixed for 5 minutes. A dynamic vacuum was applied for 10 minutes prior to the addition of 3 g of [3-(2-aminoethyl)aminopropyl]trimethoxysilane and 12 g of a premix 80/20 by weight of diisopropoxy-bis ethylacetoacetato titanate and methyl trimethoxy silane. The compound was first mixed for 5 minutes at room temperature then was mixed for 5 minutes under a dynamic vacuum. The sealant was then extruded in cartridges with the help of a press on the mixing pot and stored at room temperature.

### EXAMPLE 3

387.0 g of a 60/40 weight mixture of OH terminated polydimethylsiloxane of a molecular weight ca 160,000 in HYDROSEAL® G250H, 258.0 g of Desmoseal S XP 2636, 633.0 g of Santicizer® 261 and 15 g of Bis(1-octyloxy-2,2,6,-tetramethyl-4-piperidyl) sebacate were incorporated into a mixer and mixed for 2 minutes at room temperature. Thereafter, 723.0 g of Mickart® AC was added and mixed for 5 minutes at room temperature. 906.0 g of Socal® 312N was then added and mixed for 5 minutes at room temperature. A quantity of 66.0 g of methyl trimethoxy silane was added to the compound and mixed for 5 minutes. A dynamic vacuum was applied for 10 minutes prior to the addition of 3 g of [3-(2-aminoethyl)aminopropyl]trimethoxysilane and 12 g of a premix 80/20 by weight of diisopropoxy-bis ethylacetoacetato titanate and methyl trimethoxy silane. The compound was first mixed for 5 minutes at room temperature then was mixed for 5 minutes under a dynamic vacuum. The sealant was then extruded in cartridges with the help of a press on the mixing pot and stored at room temperature.

### COMPARATIVE EXAMPLE 1

495.0 g of a 60/40 weight mixture of OH terminated polydimethylsiloxane of a molecular weight ca 160,000 in HYDROSEAL® G250H, 249.0 g of Desmoseal S XP 2636, 606.0 g of Santicizer® 261 and 15 g of Bis(1-octyloxy-2,2,6,-tetramethyl-4-piperidyl) sebacate were incorporated into a mixer and mixed for 2 minutes at room temperature. Thereafter, 693.0 g of Mickart® AC was added and mixed for 5 minutes at room temperature. 867.0 g of Socal® 312N was then added and mixed for 5 minutes at room temperature. A quantity of 63.0 g of methyl trimethoxy silane was added to the compound and mixed for 5 minutes. A dynamic vacuum was applied for 10 minutes prior to the addition of 3 g of [3-(2-aminoethyl)aminopropyl]trimethoxysilane and 12 g of a premix 80/20 by weight of diisopropoxy-bis ethylacetoacetato titanate and methyl trimethoxy silane. The compound was first mixed for 5 minutes at room temperature then was mixed for 5 minutes under a dynamic vacuum. The sealant was then extruded in cartridges with the help of a press on the mixing pot and stored at room temperature.

### COMPARATIVE EXAMPLE 2

160.2 g of OH terminated polydimethylsiloxane of a molecular weight ca 60,000, 282 g of Desmoseal S XP 2636, 690 g of Santicizer® 261 and 15 g of Bis(1-octyloxy-2,2,6,-tetramethyl-4-piperidyl) sebacate were incorporated into a mixer and mixed for 2 minutes at room temperature. Thereafter, 786 g of Mickart® AC was added and mixed for 5 minutes at room temperature. 984 g of Socal® 312N was then added and mixed for 5 minutes at room temperature. A quantity of 69 g of methyl trimethoxy silane was added to the compound and mixed for 5 minutes. A dynamic vacuum was applied for 10 minutes prior to the addition of 3 g of [3-(2-aminoethyl)aminopropyl]trimethoxysilane and 12 g of a premix 80/20 by weight of diisopropoxy-bis ethylacetoacetato titanate and methyl trimethoxy silane. The compound was first mixed for 5 minutes at room temperature then was mixed for 5 minutes under a dynamic vacuum. The sealant was then extruded in cartridges with the help of a press on the mixing pot and stored at room temperature.

### COMPARATIVE EXAMPLE 3

156 g of OH terminated polydimethylsiloxane of a molecular weight ca 60,000 supplied by Dow Corning, 273 g of Desmoseal S XP 2636, 672 g of Santicizer 261, 78 g of trimethyl silyl terminated polydimethylsiloxane having a viscosity of 100 mPa·s at 25° C. and 15 g of bis(1-octyloxy-2,2,6,-tetramethyl-4-piperidyl) sebacate were incorporated into a mixer and mixed for 2 minutes at room temperature. Thereafter, 768 g of Mickart® AC was added and mixed for 5 minutes at room temperature. 960 g of Socal® 312N was then added and mixed for 5 minutes at room temperature. A quantity of 69 g of methyl trimethoxy silane was added to the compound and mixed for 5 minutes. A dynamic vacuum was applied for 10 minutes prior to the addition of 3 g of [3-(2-aminoethyl)aminopropyl]trimethoxysilane and 12 g of a premix 80/20 by weight of diisopropoxy-bis ethylacetoacetato titanate and methyl trimethoxy silane. The compound was first mixed for 5 minutes at room temperature then was mixed for 5 minutes under a dynamic vacuum. The sealant was then extruded in cartridges with the help of a press on the mixing pot and stored at room temperature.

### COMPARATIVE EXAMPLE 4

900.9 g of OH terminated polydimethylsiloxane of a molecular weight ca 60,000 and 324.3 g of trimethyl silyl terminated polydimethylsiloxane having a viscosity of 100 mPa·s at 25° C. were incorporated into a mixer and mixed for 2 minutes at room temperature. Thereafter, 750.8 g of Mickart® AC was added and mixed for 5 minutes at room temperature. 930.9 g of Socal® 312N was then added and mixed for 5 minutes at room temperature. A quantity of 66.1 g of methyl trimethoxy silane was added to the compound and mixed for 5 minutes. A dynamic vacuum was applied for 10 minutes prior to the addition of 3 g of [3-(2-aminoethyl)aminopropyl]trimethoxysilane and 24 g of a premix 80/20 by weight of diisopropoxy-bis ethylacetoacetato titanate and methyl trimethoxy silane. The compound was first mixed for 5 minutes at room temperature then was mixed for 5 minutes under a dynamic vacuum. The sealant was then extruded in cartridges with the help of a press on the mixing pot and stored at room temperature.

### COMPARATIVE EXAMPLE 5

1207.4 g of a 60%/40% weight mixture of OH terminated polydimethylsiloxane of a molecular weight ca 160,000 supplied by Dow Corning in HYDROSEAL® G250H and 758.0 g of Mickart® AC were incorporated into a mixer and mixed for 5 minutes at room temperature. Thereafter, 949.8 g of Socal® 312N was added and mixed for 5 minutes at room temperature. A quantity of 68.9 g of methyl trimethoxy silane was added to the compound and mixed for 5 minutes. A dynamic vacuum was applied for 10 minutes prior to the addition of 3.9 g of [3-(2-aminoethyl)aminopropyl]trimethoxysilane and 12 g of a premix 80/20 by weight of diisopropoxy-bis ethylacetoacetato titanate and methyl trimethoxy silane. The compound was first mixed for 5 minutes at room temperature then was mixed for 5 minutes under a dynamic vacuum. The sealant was then extruded in cartridges with the help of a press on the mixing pot and stored at room temperature.

### COMPARATIVE EXAMPLE 6

156 g of OH terminated polydimethylsiloxane of a molecular weight ca 43,000 supplied by Dow Corning, 273 g of Desmoseal S XP 2636, 672 g of Santicizer 261, 78 g of trimethyl silyl terminated polydimethylsiloxane having a viscosity of 100 mPa·s at 25° C. and 15 g of bis(1-octyloxy-2,2,6,-tetramethyl-4-piperidyl) sebacate were incorporated into a mixer and mixed for 2 minutes at room temperature. Thereafter, 768 g of Mickart® AC was added and mixed for 5 minutes at room temperature. 960 g of Socal® 312N was then added and mixed for 5 minutes at room temperature. A quantity of 69 g of methyl trimethoxy silane was added to the compound and mixed for 5 minutes. A dynamic vacuum was applied for 10 minutes prior to the addition of 3 g of [3-(2-aminoethyl)aminopropyl]trimethoxysilane and 12 g of a premix 80/20 by weight of diisopropoxy-bis ethylacetoacetato titanate and methyl trimethoxy silane. The compound was first mixed for 5 minutes at room temperature then was mixed for 5 minutes under a dynamic vacuum. The sealant was then extruded in cartridges with the help of a press on the mixing pot and stored at room temperature.

### Paintability Testing

Paintability testing is carried out with a water based paint (Excellence laque acrylique naturelle) on 2 mm thick sealants cured on wood. The paint is applied after the specified time. The appearance of the spreading is recorded just before application and after drying of the paint. The paint adhesion testing is carried out 7 Days after application of paint with crosshatch-tape technique following the ISO 2409 norm.

### Physical Property Testing

The tensile adhesion joints were prepared with glass using polytetrafluoroethylene (PTFE) parts to facilitate demolding. The non tin side of float glass was selected using a UV lamp and cleaned with a mixture of isopropanol (IPA)/acetone 75/25 one hour prior to the application of the sealant. The sealed tensile pieces were left to cure in a climatic chamber for the mentioned number of days at 23° C. and 50% relative humidity. After this conditioning time period, the tensile adhesion joints were tested on a Zwick tensiometer in accordance with the ISO 8339 standard at a deformation speed of 5.5 mm/min until rupture. The Young's modulus is the slope at the origin of the stress strain plot expressed in MPa. The tensile strength is the maximum stress recorded during the testing expressed in Mpa. The Elongation is the strain at break of the tensile adhesion joint expressed in %. The mode of rupture of the tensile joints was recorded according to the following rules: A failure occurring in the bulk of the sealant is recorded as a cohesive failure. A failure occurring between the sealant and the substrate leaving no trace of sealant on the substrate was recorded as an adhesive failure. A failure occurring between the sealant and the substrate but leaving a thin layer of sealant on the substrate was recorded as a boundary failure. An average of 3 values is reported in the result table. It is to be appreciated that suitable sealant formulations as discussed above must comprise a cured elastomer on which paint adheres and on which no “fish eyes” are visible.

TABLE 1
Paintability Results

| | | | | | Paint | Paint | Paint |
|---|---|---|---|---|---|---|---|
| | | | | | Adhesion | Adhesion | Adhesion |
| | | Paint | | | after 7D on the | after 7D on | after 7D on |
| | Dimethyl | spreading/cracking | Paint | Paint | surface | the surface | the surface |
| | Siloxane | on the surface | Spreading/cracking | Spreading/cracking | painted | painted | painted |
| | Content | immediately after | on 7D cured | on 28D cured | after tack free | after 7D | after 28D |
| | (%) | tack free time | surface | surface | time (%) | cure (%) | cure (%) |
| Example 1 | 5.4 | Good | Good/no cracking | Good/no cracking | 80 | 95 | 95 |
| | | spreading/high | | | | | |
| | | cracking | | | | | |
| Example 2 | 6.6 | Good spreading/ | Good/no cracking | Good/no cracking | 85 | 95 | 99 |
| | | cracking | | | | | |
| Example 3 | 7.8 | Good spreading/ | Good/no cracking | Good/no cracking | 90 | 85 | 90 |
| | | slight cracking | | | | | |
| Comparative Example 1 | 9.9 | Some Fish eyes | Some Fish Eyes/no | Good/no cracking | 95 | 5 | 0 |
| | | | cracking | | | | |
| Comparative Example 2 | 5.3 | Good/High Cracking | Good/no cracking | Good/no cracking | 100 | 95 | 50 |
| Comparative Example 3 | 7.8 | Good/Slight | Good/Slight | Good/Slight | 100 | 20 | 30 |
| | | cracking | cracking | cracking | | | |
| Comparative Example 4 | 40.8 | Some Fish eyes/no | Some Fish eyes/no | Some Fish eyes/no | 0 | 0 | 0 |
| | | cracking | cracking | cracking | | | |
| Comparative Example 5 | 24.2 | Some Fish | Many Fish eyes/no | Many Fish eyes/no | 10 | 0 | 0 |
| | | eyes/slight cracking | cracking | cracking | | | |
| Comparative Example 6 | 5.3 | Good spreading/ | Good/no cracking | Some Fish Eyes/no | 100 | 85 | 85 |
| | | slight cracking | | cracking | | | |

TABLE 2
Mechanical Properties after 21 days of cure on glass

| | Di- | | | | | |
|---|---|---|---|---|---|---|
| | methyl | Youngs | | | Modulus | |
| | siloxane | Modu- | Tensile | Elon- | at 100% | |
| | Content | lus | Strength | gation | elongation | Braking |
| | (%) | (MPa) | (MPa) | (%) | (MPa) | mode |
| Example 1 | 5.4 | 1.16 | 0.73 | 381 | 0.60 | CF |
| Example 2 | 6.6 | 1.10 | 0.66 | 374 | 0.59 | CF |
| Example 3 | 7.8 | 1.02 | 0.52 | 130 | 0.47 | AF/CF |
| Comparative | 9.9 | 0.89 | 0.52 | 209 | 0.50 | AF/CF |
| Example 1 | | | | | | |
| Comparative | 5.3 | 1.64 | 0.64 | 183 | 0.61 | CF |
| Example 2 | | | | | | |
| Comparative | 7.8 | 1.42 | 0.71 | 137 | 0.69 | AF/CF |
| Example 3 | | | | | | |
| Comparative | 40.8 | 0.89 | 0.72 | 564 | 0.43 | CF |
| Example 4 | | | | | | |
| Comparative | 24.2 | 0.59 | 0.76 | 496 | 0.40 | AF/CF |
| Example 5 | | | | | | |
| Comparative | 5.3 | 1.7 | 0.74 | 80 | NA | AF/CF |
| Example 6 | | | | | | |

CF = Cohesive Failure;
AF = Adhesive Failure
AF/CF = a mixture of adhesive and cohesive failure

The examples in accordance with the present invention show significantly better paintability (spreading and adhesion) with good mechanical properties (low modulus at 100%, high elongation). It will be noted that the comparatives gave overall poorer results.

1. A curable composition capable of cure to an elastomeric body, the composition comprising:
(a) a diluted polymer comprising
(i) a high molecular weight organopolysiloxane polymer having an organopolysiloxane chain having a number average molecular weight (Mₙ) of at least 100,000 and terminal groups selected from either silanol and/or other hydrolysable groups; or unsaturated groups; and
(ii) one or more an organic plasticiser(s) and/or one or more organic extender(s) or a mixture thereof;
(b) a suitable amount of one or more suitable cross-linkers for cross-linking (a);
(c) a suitable amount of catalyst;
(d) one or more fillers; and
either (e) or (f), selected to chemically interact with (a) and (b), wherein
(e) is one or more organic polymers having terminal and/or pendent silyl groups containing —OH functional groups or hydrolysable functional groups, and
(f) is one or more organic polymers having terminal and/or pendent silyl groups containing one or more unsaturated groups, selected in accordance with the terminal groups of (a);
wherein the composition comprises up to 8% by weight of the high molecular weight organopolysiloxane polymer in component (a).

2. A curable composition capable of cure to an elastomeric body wherein the composition is obtainable by:
(I) polymerising an organopolysiloxane containing monomer or oligomer polymer in the presence of one or more organic plasticiser(s) and/or one or more organic extender(s) or a mixture thereof via a polycondensation, ring opening, polyaddition or chain extension reaction pathway, to form a diluted polymer product (a) comprising an organopolysiloxane chain having a number average molecular weight (Mₙ) of at least 100,000 and terminal groups selected from either silanol and/or other hydrolysable groups; or unsaturated groups;
(II) mixing the diluted polymer product (a) with
(b) a suitable amount of one or more suitable cross-linkers for cross-linking (a)
(c) a suitable amount of catalyst
(d) one or more fillers; and
either (e) or (f), selected to chemically interact with (a) and (b), wherein
(e) is one or more organic polymers having terminal and/or pendent silyl groups containing —OH functional groups or hydrolysable functional groups, and
(f) is one or more organic polymers having terminal and/or pendent silyl groups containing one or more unsaturated groups, selected in accordance with the terminal groups of (a);
wherein the composition comprises up to 8% by weight of the high molecular weight organopolysiloxane polymer in component (a).

3. A curable composition in accordance with claim 1 wherein the one or more silyl terminated organic polymers in components (e) or (f) are selected from silyl terminated polyurethanes, silyl terminated polyethers, silyl terminated (meth)acrylates, silyl terminated saturated hydrocarbon polymers, and/or mixtures thereof.

4. A curable composition in accordance with claim 1 wherein filler (d) comprises one or more finely divided, reinforcing fillers selected from high surface area fumed and precipitated silicas, calcium carbonate and/or one or more finely divided, semi-reinforcing or non-reinforcing fillers selected from crushed quartz, diatomaceous earths, barium sulphate, iron oxide, titanium dioxide and carbon black, talc, wollastonite, aluminite, calcium sulphate (anhydrite), gypsum, calcium sulphate, magnesium carbonate, clays, aluminium trihydroxide, magnesium hydroxide, graphite, copper carbonate, nickel carbonate, barium carbonate, strontium carbonate, aluminium oxide, silicates from the group consisting of olivine group silicates; garnet group silicates; aluminosilicates; ring silicates; chain silicates; and sheet silicates.

5. A curable composition in accordance with claim 1 wherein diluted polymer (a) and the one or more organic polymers (e) contain groups selected from —OH or hydrolysable groups and cross-linker (b) is selected from one or more of a disilaalkanes, alkyltrialkoxysilanes, alkenyltrialkoxy silanes, phenyltrimethoxysilane, alkoxytrioximosilane, alkenyltrioximosilane, 3,3,3-trifluoropropyltrimethoxysilane, methyltriacetoxysilane, vinyltriacetoxysilane, ethyl triacetoxysilane, di-butoxy diacetoxysilane, phenyl-tripropionoxysilane, methyltris(methylethylketoximo)silane, vinyl-tris-(methylethylketoximo) silane, methyltris(methylethylketoximino)silane, methyltris(isopropenoxy)silane, vinyltris(isopropenoxy)silane, ethylpolysilicate, n-propylorthosilicate, ethylorthosilicate and dimethyltetraacetoxydisiloxane, alkylalkenylbis(N-alkylacetamido) silanes, dialkylbis(N-arylacetamido) silanes; alkylalkenylbis(N-arylacetamido) silanes, or dimethyldi-(N-phenylacetamido) silane.

6. A curable composition in accordance with claim 5 wherein catalyst (c) is a condensation catalyst selected from organic tin IV metal catalysts, tin II catalysts, 2-ethylhexoates of iron, cobalt, manganese, lead and zinc, optionally chelated titanates and optionally chelated zirconates.

7. (canceled)

8. A curable composition in accordance with claim 1 wherein diluted polymer (a) and the one or more silyl terminated organic polymers (b) contain unsaturated groups and cross-linker (b) is selected from one or more organohydrogensiloxane molecules having at least 3 silicon-bonded hydrogen atoms per molecule in an amount which is sufficient to give a molar ratio of Si—H groups in the organohydrogensiloxane to the total amount of alkenyl groups in polymers (a) and (f) of from 1/1 to 10/1.

9. A curable composition in accordance with claim 8 wherein catalyst (c) is a platinum group hydrosilylation catalyst containing platinum, rhodium, iridium, palladium or ruthenium.

10. A curable composition in accordance with claim 1 further comprising one or more adhesion promoters and/or fungicides.

11. A curable composition in accordance with claim 1 wherein organic polymer (e) has terminal silyl groups or pendent silyl groups.

12. A curable composition in accordance with claim 1 further comprising a component (g) in the form of one or more plasticiser(s) and/or extender(s) miscible with component (e) or (f) and selected from the group of dialkyl phthalates, adipate, azelate, oleate and sebacate esters, polyols, and organic phosphates.

13. A method of preparing a curable composition capable of cure to an elastomeric body by:
(I) polymerising an organopolysiloxane containing monomer or oligomer polymer in the presence of one or more organic plasticiser(s) and/or one or more organic extender(s) or a mixture thereof via a polycondensation, ring opening, polyaddition or chain extension reaction pathway, to form a diluted polymer product (a) comprising an organopolysiloxane chain having a number average molecular weight (Mn) of at least 100,000 and terminal groups selected from either silanol and/or other hydrolysable groups; or unsaturated groups;
(II) mixing the diluted polymer product (a) with
(b) a suitable amount of one or more suitable cross-linkers for cross-linking (a)
(c) a suitable amount of catalyst
(d) one or more fillers; and
either (e) or (f), selected to chemically interact with (a) and (b), wherein
(e) is one or more organic polymers having terminal and/or pendent silyl groups containing —OH functional groups or hydrolysable functional groups, and
(f) is one or more organic polymers having terminal and/or pendent silyl groups containing one or more unsaturated groups, selected in accordance with the terminal groups of (a);
wherein the composition comprises up to 8% by weight of the high molecular weight organopolysiloxane polymer in component (a).

14. A method in accordance with claim 13 further comprising component (g), in the form of one or more plasticiser(s) and/or extender(s) miscible with components (e) or (f) and selected from the group of dialkyl phthalates, adipate, azelate, oleate and sebacate esters, polyols, and organic phosphates, which is intermixed with component (e) or (f) prior to introduction into the composition or is added directly into the composition without premixing in component (e) or (f).

15. (canceled)

16. A method of sealing a space between two units, said method comprising applying a composition in accordance with claim 1 and causing or allowing the composition to cure.

17. A glazing structure or building unit which includes a sealant derived from a composition according to claim 1.

18. A paintable elastomeric body obtainable by curing a composition in accordance with claim 1.

19. An elastomeric body in accordance with claim 18 having a surface with an at least partial coating of paint.

20. An elastomeric body in accordance with claim 18 wherein the elastomeric body is a joint sealant, an adhesive, a moulded body, a coating or a formed-in-place gasket.

21. A method of producing a cured silicone elastomer with a surface coated with a hardened protective coating, said method comprising; exposing a composition in accordance with claim 1 to moisture until a cured elastomeric surface is obtained and a homogeneous dull surface develops, thereafter applying a protective coating composition, hardenable at ambient conditions, over at least a portion of the cured elastomeric surface where the protective coating composition wets the surface to which it is applied and produces an essentially flaw-free film and, thereafter, allowing the protective coating composition to harden.

22. A multi-pack sealant composition according to claim 1 comprising a first pack comprising polymer (a) and filler (d) and a second pack comprising catalyst (c) and cross-linker (b), and wherein organic polymer (e) or (f) is in either or both said first and second packs.
